(19) United States
(12) Patent Application Publication
(10) Pub. No.: US 2010/0230362 A1
(43) Pub. Date: Sep. 16, 2010

(54) FLUID PURIFICATION

(76) Inventor: John R. Lersch, Gallipolis, OH (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/402,113

(22) Filed: Mar. 11, 2009

(51) Int. Cl. C02F 5/02; C02F 1/48; C02F 1/58

(52) U.S. Cl. 210/695; 210/737; 210/181

(57) ABSTRACT

A fluid purification system and method thereof, the system comprising a plurality of components serially coupled and in fluid communication. A pipe or conduit introduces a fluid into the system and communicates with a charging device that removes surface charge(s) from the fluid. The fluid is then transferred to a heater for raising the temperature of the fluid and providing the conditions for precipitating mineral material that generally causes build-up and/or corrosion within such a system. The fluid is then carried to a tank or tanks for precipitation of the mineral material. The resulting supernate and precipitate are transferred to a separator and further separated, with the precipitate withdrawn and the filtered fluid transferred for additional filtering downstream.

### BACKGROUND

Certain embodiments of the invention pertain to fluid purification.

One non-exhaustive example of related technology is described in U.S. Pat. No. 4,956,083, issued to Tovar, disclosing a water purification device including a hollow casing split into a pair of mating sections releasably connected together for easy access to the inside of the casing. A water pipe is disposed in the casing, extends out opposite ends thereof and bears connectors for connection to water-bearing plumbing and the like. A non-rotating removable and replaceable water impeller having a spaced number of blade segments is disposed longitudinally on the water pipe to control mixing and the residence time of water passing through the pipe. The impeller can be in the form of a single helix or in the form of a flexible accordion-pleated band which is longitudinally urgeable between a collapsed and an extended position to control the number and pitch of the blade segments or pleats in a selected portion of the pipe. That selected portion is disposed in an electromagnetic coil in the casing, which coil, when energized, causes sediment in the water to dissolve and pulverize. The coil is energized through electrical components in the casing, including a condenser, a transformer, a resistor and electrical circuitry interconnected to the coil. The device is compact and efficient. This example, as well as other related technology, discloses multi-stage vessels using individual separator/coalescer filter elements to separate solids, filter liquids, and coalesce liquids.

Certain embodiments of the invention represent improvements pertaining to purifying a quantity of fluid.

### SUMMARY

Certain embodiments of the invention include a feature for improving the quantity of particulates removed from a fluid directed through the fluid purification device.

Certain embodiments of the invention include a charging device removing surface charge(s) from the fluid. In one embodiment, the charging device may comprise one or more magnets. In another embodiment, the charging device may comprise one or more electromagnetic coils.

Certain embodiments of the invention include a heat exchanger generating additional and regenerative heat applied to the inbound fluid.

The “Summary of the Invention” is provided merely to introduce certain concepts. The “Summary of the Invention” is not intended to identify any key or essential feature of the claimed subject matter.

### BRIEF DESCRIPTION OF THE DRAWINGS

FIG. 1 is a schematic of one embodiment of a mineral precipitation system;

FIG. 2 is a schematic of another embodiment of a mineral precipitation system;

FIG. 3 is a schematic of another embodiment of a mineral precipitation system;

FIG. 4a is a side view of a charging device comprising a plurality of magnets provided in a stacked orientation; and

FIG. 4b is a side view of a charging device comprising a plurality of magnetic coils provided in stacked orientation.

### DESCRIPTION OF THE EMBODIMENT(S)

As used herein, “fluid” may be a solid, liquid, gas or other composition that flows and changes its shape or form when acted upon by a force.

As used herein, a “surface charge” is an electrical charge generated through the interaction of a material in a fluid.

As used herein, “coupled” may include components, apparatuses, devices or other articles that are joined or otherwise attached, such as movably or fixedly, by one or more intermediate components, apparatuses, devices or other articles.

As used herein, “in electrical communication” may include components, apparatuses, devices or other articles that transfer electrical energy through one or more intervening components, apparatuses, devices or other articles and/or in which the transferred electrical energy is modified as part of the transfer.

As used herein, “in fluid communication” includes the flow of fluid from one components, apparatus, device, article or region to another component, apparatus, device, article or region; such flow may be achieved by way of one or more intermediate (and not specifically mentioned or described) other components, apparatuses, devices, articles or regions, and such flow may or may not be selectively interruptible (such as by a valve, switch, control or other suitable component).

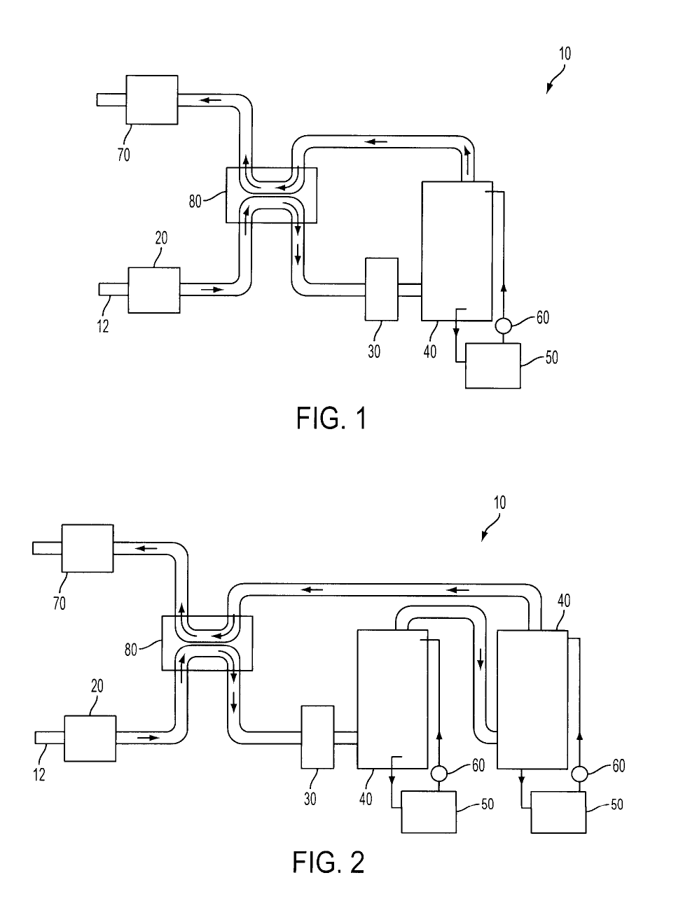

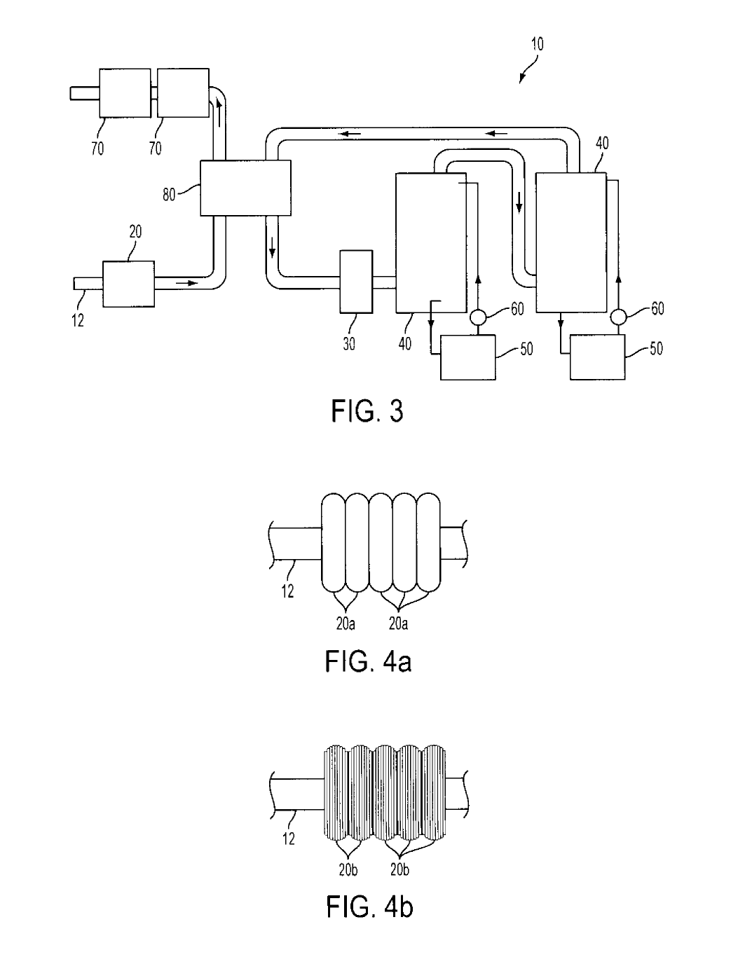

Referring now to FIG. 1, a purification system for removing contaminants and other unwanted or undesirable particulates from a fluid is depicted and generally denoted by the reference character 10. In one embodiment, the system 10 may comprise a charging device 20, a heater 30, at least one precipitation tank 40, a separator 50, a pump 60, and at least one filter 70. In this embodiment, the system 10 and its various components may be directly or indirectly coupled by one or more pipes or conduits 12 provided within, through and/or between the components. In another embodiment, the system 10 may further comprise a heat exchanger 80. In this embodiment, the system 10 and its various components may be directly or indirectly coupled by one or more pipes or conduits provided within, through and/or between the components. In the embodiments, the various components may be collectively or separately supplied with electricity for operation.

It is envisioned that the most common fluid interacting with the system 10 is water, though other fluid materials and combinations of water with these other fluid materials are contemplated.

A pipe or conduit 12 supplies and introduces an inbound current of fluid “F” to the system 10. In one embodiment, a water circulation system provides the quantity of water (as the fluid) introduced into the system for purification via the pipe 12. The pipe 12 may pass through or by the charging device 20. In one embodiment, the charging device 20 may comprise one or more annular magnets 20a disposed in a stacked orientation. In another embodiment, the charging device 20 may comprise one or more electromagnetic coils 20b disposed in a stacked orientation. It is envisioned that the polarity of each magnet 20a or coil 20b in the stacked orientation may be similar or variable when comparing adjacent magnets 20a or coils 20b. It is further envisioned that one embodiment includes a configuration in which the magnets 20a or coils 20b have sequentially or serially opposing polarities. As but one example, it is envisioned that one configuration of the magnets 20a or coils 20b may include alternating polarities, such as N-S, S-N, N-S, S-N. Other configurations are contemplated, as well. The electromagnetic coils 20b may be energized by one of the following arrangements, including electrical current from a source.

Magnets 20a or coils 20b remove surface (electrical) charges from the minerals carried by the fluid “F”, the surface charge(s) generated by the interaction of the mineral(s) in the fluid. In removing the surface charge(s) of the mineral(s), cleavage of any bonding or attraction between the fluid (e.g. water) and the mineral(s) is optimized, thereby allowing the mineral(s) to more freely precipitate from the fluid under the appropriate conditions. The resulting precipitate may then be separated from the remaining supernate (liquid) portion. The precipitate represents a significant quantity of the undesirable mineral build-up experienced in water or fluid circulation and/or filtering systems. Thus, optimizing separation of the precipitate from the fluid (e.g. water), and discarding the precipitate, represents an improvement over other systems in improving fluid purification and reducing maintenance and/or replacement of elements or components of the system 10.

In embodiments in which the fluid is water, the water passes through the pipe 12 and either through or by the magnets 20a or coils 20b removing the static charge and starting the crystal nucleation process that continues through the system and into the tank(s) 40 utilized in precipitating the mineral material from the water.

The heating unit or heater 30, or a plurality of heaters comprising a heating unit 30, may be utilized to increase the temperature of the fluid (e.g. water) beyond a threshold conducive for precipitation of the solid mineral material from the fluid material. In one embodiment, the heater(s) 30 may be in fluid communication with the charging device 20. In another embodiment, described below that may utilize a heat exchanger 80, the heater(s) 30 may be in fluid communication with the heat exchanger 80. A pipe or component of the pipe 12 may provide the fluid coupling or communication between the heater(s) 30 and the charging device 20, or the heater(s) 30 and the heat exchanger 30, respectively. Downstream, the fluid may be transferred to one or more tanks 40 via the pipe 12, a component of the pipe 12, or other conduit for transferring fluid to the tank(s) 40.

It is envisioned that the temperature range necessary to force precipitation is between 120° F. and 180° F. The variability within the range will accommodate variable chemical characteristics and process parameters for a particular fluid sample and purification or precipitation systems. Heating the fluid lowers the saturation point of the fluid and increases the crystallization process that yields a separable precipitate. The velocity of the fluid is such that the precipitate is not generated until transfer of the fluid into one or more tank(s) 40 within the system.

The tank 40, or a plurality of tanks 40, may be used for facilitating precipitation of the solid material once the temperature threshold parameter is satisfied. Once the heated fluid (e.g. water) enters the tank 40, the velocity of the fluid is slowed so that the precipitate is formed. The precipitate may have many textural or structural forms, including flakes, powder or grain, generally influenced by the composition of the fluid and the minerals bonded therewith. As the precipitate forms, adding mass and generally under the influence of gravity, the precipitate particles descend to the base or floor of the tank 40. The tank 40 is coupled to a separator 50 for further treatment of the precipitate.

The separator 50 may comprise a variety of commercially available separators, including a centrifugal separator, a vacuum separator or other similar and suitable separator that may be incorporated into the aforementioned system 10. The separator 50 further separates precipitate material from the fluid transferred to the separator 50. As the precipitate forms, and accumulates, the yield descends to the base or bottom of the separator 50, with the residual fluid circulated into the tank 40 by a variety of ways, including the use of a pump 60 within the system 10. The precipitate may then be permanently removed from the system 10 via a separate discharge or through periodic cleaning or maintenance.

The pump 60 may be disposed between and operatively coupled between the separator 50 and the tank 40, with the pump 60 inducing flow of the separated fluid from the separator 50 back into the tank 40. Thereafter, the fluid may be induced into circulation for further treatment by another tank 40/separator 50/pump 60 configuration, a heat exchanger 80 or one or more filters 70. It is envisioned that a combination or subcombination of one or more of these components may be utilized in the purification of the fluid after a first purification through the tank 40/separator 50/pump 60 configuration is performed.

It is envisioned that at least one filter 70, and conceivably multiple filters 70, may be utilized in the system 10, the filter or filters 70 coupled with the pipe or conduit 12 delivering or transporting the resulting outbound fluid throughout the system 10. In one embodiment, one or more filters 70 are positioned near the end of the purification system 10 (and process), the filter(s) 70 further capturing any residual precipitate or other solid or semi-solid material that may be trapped or entrained by the filter media(-um) utilized in the filter(s) 70. It is also envisioned that one or more filters 70 may be disposed at various places and stages within the system 10 (and process). If the fluid, including water, is heavily contaminated with minerals or other undesirable properties, the use of one or more filters 70 within the system 10 (and process) may yield better purification for the fluid without having to re-circulate the fluid through the entire system 10 (and process).

If optionally included, the heat exchanger 80 may be disposed to take advantage of the heat carried by the fluid from the circulation of partially treated or purified fluid to heat the inbound current of fluid just entering the purification system. As depicted in FIG. 1, the heat exchanger 80 may be disposed between the charge device 20 and heating unit or heater(s) 30 on the inbound stage, and disposed between the tank(s) 40 and the filter(s) 70 on the outbound stage. In this configuration, the heat exchanger 80 is envisioned as comprising a countercurrent or cross-current exchanger. For example, the specific depiction of FIG. 1 is that of a countercurrent exchanger, in which the inbound current and outbound current passing through the exchanger are oriented in opposite directions (though flowing parallel or substantially parallel through the system 10). In a cross-current (cross-flow) exchanger, the inbound current and outbound current are oriented at some angle to one another that is not substantially parallel in orientation. These types of exchangers optimize the heat created by the system 10 by transferring the heat by-product from the purification to the inbound fluid current that is to be heated in various stages. In this arrangement, the heat required from the heater(s) 30 is reduced, thereby reducing the strain on the heater(s) 30 and extending the usable life thereof. However, the heat exchanger 80 is not limited to these particular configurations or apparatuses, and may comprise various types of exchangers commercially available.

It is to be understood that the embodiments and claims are not limited in application to the details of construction and arrangement of the components set forth in the description and illustrated in the drawings. Rather, the description and the drawings provide examples of the embodiments envisioned, but the claims are not limited to any particular embodiment or a preferred embodiment disclosed and/or identified in the specification. The drawing figures are for illustrative purposes only, and merely provide practical examples of the invention disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

Furthermore, the Abstract is neither intended to define the claims of the application, nor is it intended to be limiting to the scope of the claims in any way. It is intended that the application is defined by the claimed appended hereto.

What is claimed is:

1. A method for removing mineral impurities from a fluid, the method comprising the steps of:
removing surface charges from a fluid introduced therewith;
heating the fluid;
separating the minerals from the fluid yielding a precipitate and a supernate;
introducing the supernate and the precipitate into a separator;
separating the supernate and the precipitate;
withdrawing the precipitate;
pumping the fluid to a first tank;
introducing the fluid to at least one filter; and
separating residual minerals from the fluid via the at least one filter.

2. The method of claim 1, wherein the step of removing surface charges from a fluid includes the fluid communicating with a charging device.

3. The method of claim 1, wherein the step of heating the fluid includes raising the temperature of the fluid to between 120° F. and 180° F.

4. The method of claim 1, wherein the step of separating the minerals from the fluid includes introducing the fluid into the first tank.

5. The method of claim 1 further comprising the step of heating the fluid includes introducing the fluid into a heat exchanger.

6. The method of claim 1 further comprising the step of repeating the separating of the minerals from the fluid by introducing the fluid into a second tank.

7. A fluid purification system comprising:
a charging device;
a heater;
at least one precipitation tank;
a separator in fluid communication;
a pump;
at least one filter; and
at least one conduit in fluid communication with the charging device through the at least one filter.

8. The system of claim 7, wherein the charging device comprises at least one magnet.

9. The system of claim 8 further comprising a plurality of magnets disposed in a stacked configuration.

10. The system of claim 9, wherein the plurality of magnets are arranged in alternating polarities.

11. The system of claim 7, wherein the charging device comprises at least one electromagnetic coil.

12. The system of claim 11 further comprising a plurality of electromagnetic coils disposed in a stacked configuration.

13. The system of claim 12, wherein the plurality of electromagnetic coils are arranged in alternating polarities.

14. The system of claim 7, wherein the heater raises the temperature of the fluid to between approximately 120° F. and 180° F.

15. A fluid purification system comprising:
a charging device;
a heat exchanger;
a heater;
at least one precipitation tank;
a separator in fluid communication with the tank;
a pump in fluid communication with the separator and the tank;
at least one filter; and
at least one conduit in fluid communication with the charging device through the at least one filter.

16. The system of claim 15, wherein the charging device comprises at least one magnet.

17. The system of claim 16 further comprising a plurality of magnets disposed in a stacked configuration.

18. The system of claim 17, wherein the plurality of magnets are arranged in alternating polarities.

19. The system of claim 15, wherein the charging device comprises at least one electromagnetic coil.

20. The system of claim 19 further comprising a plurality of electromagnetic coils disposed in a stacked configuration.

21. The system of claim 20, wherein the plurality of electromagnetic coils are arranged in alternating polarities.

22. The system of claim 15, wherein the heater raises the temperature of the fluid to between approximately 120° F. and 180° F.

23. The system of claim 15, wherein the heat exchanger is disposed between the charging device and the tank.
